(19) United States
(12) Patent Application Publication
(10) Pub. No.: US 2014/0364965 A1
(43) Pub. Date: Dec. 11, 2014

(54) FUNCTION CONTROL DEVICE AND FUNCTION ADDING DEVICE

(71) Applicants: KABUSHIKI KAISHA TOSHIBA, Tokyo (JP); TOSHIBA LIFESTYLE PRODUCTS & SERVICES CORPORATION, Tokyo (JP)

(72) Inventors: Yutaka YAMADA, Tokyo (JP); Masayuki TOKUNAGA, Tokyo (JP)

(21) Appl. No.: 14/467,667

(22) Filed: Aug. 25, 2014

Related U.S. Application Data
(63) Continuation of application No. PCT/JP2013/065287, filed on May 31, 2013.

(51) Int. Cl. G05B 15/02

(52) U.S. Cl. CPC G05B 15/02
USPC 700/19

(57) ABSTRACT

According to one embodiment, a function control device includes an interface, an acquisition module, and a controller. The interface is connectable to at least one of multiple types of function adding devices. The acquisition module acquires, from the function adding device connected via the interface, function information indicating a function executed by the function adding device. The controller accesses, upon controlling the function indicated by the function information acquired by the acquisition module, an address which is determined as a common address for the function identified by the function information and which is in a storage module comprised in the function adding device connected via the interface.

### CROSS-REFERENCE TO RELATED APPLICATIONS

This application is a continuation of international application No. PCT/JP2013/065287, filed on May 31, 2013, which designates the United States, the entire contents of which are incorporated herein by reference.

### FIELD

Embodiments described herein relate generally to a function control device and a function adding device.

### BACKGROUND

Conventionally, as for products distributed in markets, it has been necessary to develop multiple types of the products according to regions or price ranges of providing destinations.

In recent years, to reduce development costs, there has been proposed a technique for facilitating enhancement and change of functions by modularization when developing multiple types of products.

However, in the conventional technique, even when the enhancement and change of the functions are realized in units of modules, because a supported function or the like is different for each of the modules, it has been necessary to install programs corresponding to the respective modules.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a concept of a video processing device according to a first embodiment;

FIG. 2 is an exemplary diagram illustrating a detailed configuration of the video processing device in the first embodiment;

FIG. 3 is an exemplary diagram illustrating a software configuration realized by a host processor in the first embodiment;

FIG. 4 is an exemplary conceptual diagram illustrating a control method of a main board and a sub board in the first embodiment;

FIG. 5 is an exemplary diagram illustrating an example of type-specific function information for each module type in the first embodiment;

FIG. 6 is an exemplary diagram illustrating an example of address map of a register of a tuner module, which is stored in an address information storage module in the first embodiment;

FIG. 7 is an exemplary diagram illustrating a structure of a first sub board in the first embodiment;

FIG. 8 is a diagram illustrating a configuration of a register in a first peripheral device mounted on the sub board in the first embodiment;

FIG. 9 is an exemplary diagram illustrating a register configuration of a tuner board in the first embodiment.

FIG. 10 is an exemplary diagram illustrating a register configuration of a moving image function in the first embodiment;

FIG. 11 is an exemplary diagram illustrating a register configuration of a recording function in the first embodiment;

FIG. 12 is an exemplary diagram illustrating a register configuration of an image quality improvement function in the first embodiment;

FIG. 13 is an exemplary flowchart illustrating the flow of a process performed at the time of activation of the video processing device in the first embodiment;

FIG. 14 is an exemplary flowchart illustrating the flow of setting the tuner module in the video processing device in the first embodiment;

FIG. 15 is an exemplary diagram illustrating an example of address mapping of a register in a tuner controller of a tuner module according to a modification of the first embodiment; and

FIG. 16 is an exemplary diagram illustrating a structure of a first sub board according to a second embodiment.

### DETAILED DESCRIPTION

In general, according to one embodiment, a function control device includes an interface, an acquisition module, and a controller. The interface is connectable to at least one of multiple types of function adding devices. The acquisition module acquires, from the function adding device connected via the interface, function information indicating a function executed by the function adding device. The controller accesses, upon controlling the function indicated by the function information acquired by the acquisition module, an address which is determined as a common address for the function identified by the function information and which is in a storage module comprised in the function adding device connected via the interface.

### First Embodiment

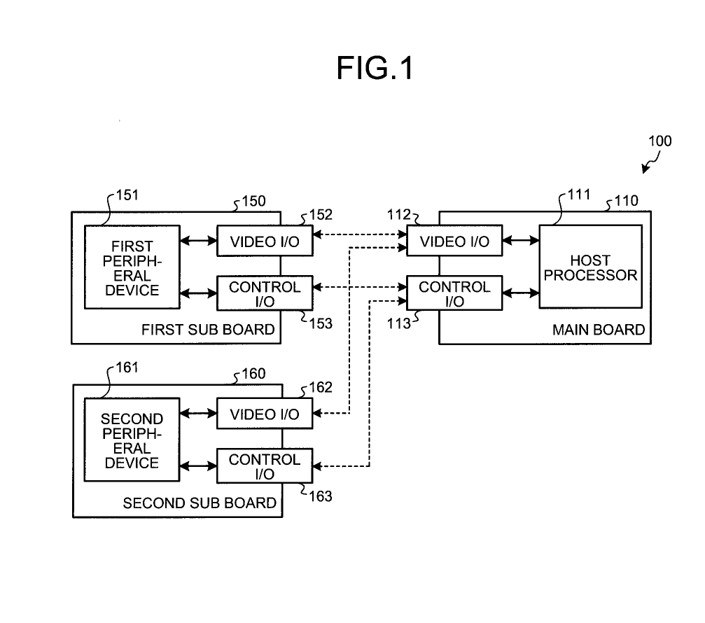

FIG. 1 is a diagram illustrating a concept of a video processing device 100 according to a first embodiment. In an example illustrated in FIG. 1, at least one or more of a first sub board 150 and a second sub board 160 are connectable to a main board 110.

The present embodiment is an example in which the main board 110 is provided as a function control device that controls functions installed in the first sub board 150 and the second sub board 160, and the first sub board 150 and the second sub board 160 are provided as function adding devices that add functions to the main board 110.

The main board 110 comprises a host processor 111, a video interface (I/O) 112, and a control interface (I/O) 113.

Meanwhile, the first sub board 150 comprises a first peripheral device 151, a video interface (I/O) 152, and a control interface (I/O) 153. Further, the second sub board 160 comprises a second peripheral device 161, a video interface (I/O) 162, and a control interface (I/O) 163.

As illustrated in FIG. 1, the first sub board 150 and the second sub board 160 have the same interfaces, and therefore both are connectable to the main board 110. Namely, when the first sub board 150 is connected to the main board 110, the host processor 111 can control the first peripheral device 151 by transmitting and receiving control signals via the control interface 113 and the control interface 153. Similarly, when the second sub board 160 is connected to the main board 110, the host processor 111 can control the second peripheral device 161 by transmitting and receiving control signals via the control interface 113 and the control interface 163. Incidentally, while an example will be described in which video signals and control signals are transmitted in the present embodiment, it may be possible to communicate signals other than these signals. For example, it may be possible to provide a data bus for transmitting and receiving signals or the like for connecting to the Internet.

Conventionally, in development of video processing devices such as television display devices, the development has been performed for each region and each price range. In this case, even when there are components with a common function, it is necessary to perform the development for each region and for each price range; therefore, there is a problem in that development burdens and development costs increase. Therefore, to realize the same function (module), if sub boards developed for respective regions and respective price ranges (performances) are configured to be detachably attachable to a main board, it becomes possible to reduce development costs.

However, even if the sub boards are simply configured to be detachably attachable, to trigger functions of sub boards to be connected, a host processor of the main board that controls these sub boards needs to be equipped with programs corresponding to the sub boards to be connected. In this case, it is necessary to develop the programs corresponding to the respective sub boards.

In contrast, the present embodiment provides a common register configuration of a sub board for each module (function) type and provides a common program for accessing this register configuration in order to reduce development burdens.

In other words, in conventional PCs or the like, even if a common interface, such as a bus, is provided, when functions installed in the first peripheral device 151 and the second peripheral device 161 are different from each other, it is necessary to install programs (device drivers) or the like to be executed by the host processor 111. In contrast, the present embodiment realizes a technique for eliminating the need to change a program to be executed by the host processor 111 in either case where the first sub board 150 or the second sub board 160 is connected.

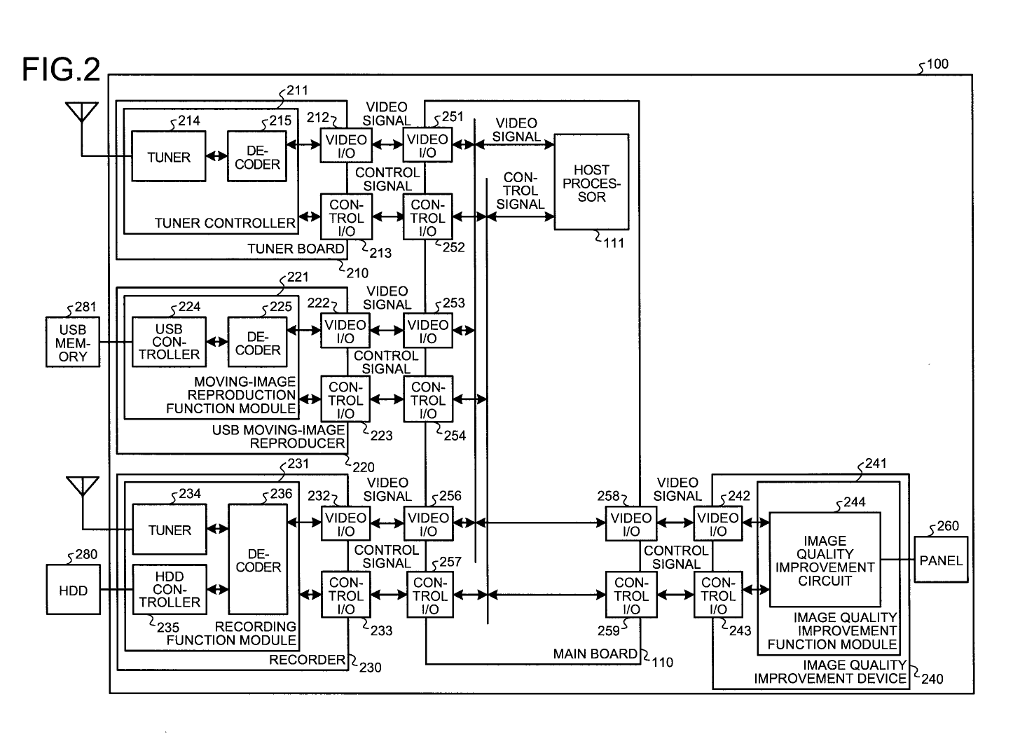

FIG. 2 is a diagram illustrating a detailed configuration of the video processing device 100 according to the present embodiment. The video processing device 100 illustrated in FIG. 2 comprises the main board 110, a tuner board 210, a USB moving-image reproducer 220, a recorder 230, and an image quality improvement device 240.

In this manner, in the example illustrated in FIG. 2, four sub boards (the tuner board 210, the USB moving-image reproducer 220, the recorder 230, and the image quality improvement device 240) are connected to the single main board 110 by way of example. However, the present embodiment does not limit the sub boards to the tuner board 210, the USB moving-image reproducer 220, the recorder 230, and the image quality improvement device 240, and any devices that provide functions to the main board 110 are applicable.

Further, a peripheral circuit provided in the sub board may be connected to a device other than the main board 110. In the example in FIG. 2, a tuner 214 of the tuner board 210 is connected to an external antenna, the USB moving-image reproducer 220 is connected to a USB memory 281 via a USB controller 224, a tuner 234 and an HDD controller 235 of the recorder 230 are respectively connected to an antenna and an HDD 280, and the image quality improvement device 240 is connected to a panel 260.

The tuner board 210 comprises a tuner controller 211, a video interface 212, and a control interface 213. The tuner controller 211 comprises the tuner 214 and a decoder 215.

Further, each of the components mounted on the tuner controller 211 performs control according to a control signal transmitted from the host processor 111 via the control interface 213. For example, after the tuner 214 receives a broadcast signal from an external antenna according to the control signal, the decoder 215 decodes the broadcast signal to a video signal, and thereafter, the video interface 212 transmits the video signal to the host processor 111.

The USB moving-image reproducer 220 comprises a moving-image reproduction function module 221, a video interface 222, and a control interface 223. The moving-image reproduction function module 221 comprises the USB controller 224 and a decoder 225.

Further, each of the components mounted on the moving-image reproduction function module 221 performs control according to a control signal transmitted from the host processor 111 via the control interface 223. For example, after the USB controller 224 reads moving image data from the USB memory 281 according to the control signal, the decoder 225 decodes the moving image data to a video signal, and thereafter, the video interface 222 transmits the video signal to the host processor 111.

The recorder 230 comprises a recording function module 231, a video interface 232, and a control interface 233. The recording function module 231 comprises the tuner 234, the HDD controller 235, and a decoder 236. The recorder 230 performs the same processes as those of the tuner controller 211 and the USB moving-image reproducer 220, and transmits a video signal to the host processor 111.

The image quality improvement device 240 comprises an image quality improvement function module 241, a video interface 242, and a control interface 243. The image quality improvement function module 241 comprises an image quality improvement circuit 244.

Further, the image quality improvement circuit 244 mounted on the image quality improvement function module 241 performs control according to a control signal transmitted from the host processor 111 via the control interface 243. For example, the image quality improvement circuit 244 performs image quality improvement control on an input video signal according to the control signal, and thereafter outputs the video signal subjected to the image quality improvement control to the panel 260. Consequently, the video signal subjected to the image quality improvement control is displayed.

Meanwhile, the control signals from the host processor 111 according to the present embodiment are used to access (read and write) registers in peripheral devices of the sub boards (the tuner board 210, the USB moving-image reproducer 220, the recorder 230, and the image quality improvement device 240). Further, the sub boards (the tuner board 210, the USB moving-image reproducer 220, the recorder 230, and the image quality improvement device 240) control devices thereof according to information written in the registers.

The main board 110 comprises the host processor 111, video interfaces 251, 253, 256, and 258, and control interfaces 252, 254, 257, and 259.

The video interfaces 251, 253, 256, and 258 are bus interfaces for transmitting and receiving video signals with respect to the sub boards (the tuner board 210, the USB moving-image reproducer 220, the recorder 230, and the image quality improvement device 240). The control interfaces 252, 254, 257, and 259 are bus interfaces for transmitting and receiving control signals with respect to the sub boards (the tuner board 210, the USB moving-image reproducer 220, the recorder 230, and the image quality improvement device 240).

In the example illustrated in FIG. 2, the control signals transmitted and received between the host processor 111 and the sub boards (the tuner board 210, the USB moving-image reproducer 220, the recorder 230, and the image quality improvement device 240) are routed through the bus interfaces (the control interfaces 252, 254, 257, and 259). However, the present embodiment does not limit the route of the control signals to the bus interfaces, and any interfaces that can communicate with the sub boards (the tuner board 210, the USB moving-image reproducer 220, the recorder 230, and the image quality improvement device 240) are applicable.

The host processor 111 reads a control program stored in a ROM (not illustrated) to thereby realize a configuration for controlling each of the modules of the video processing device 100.

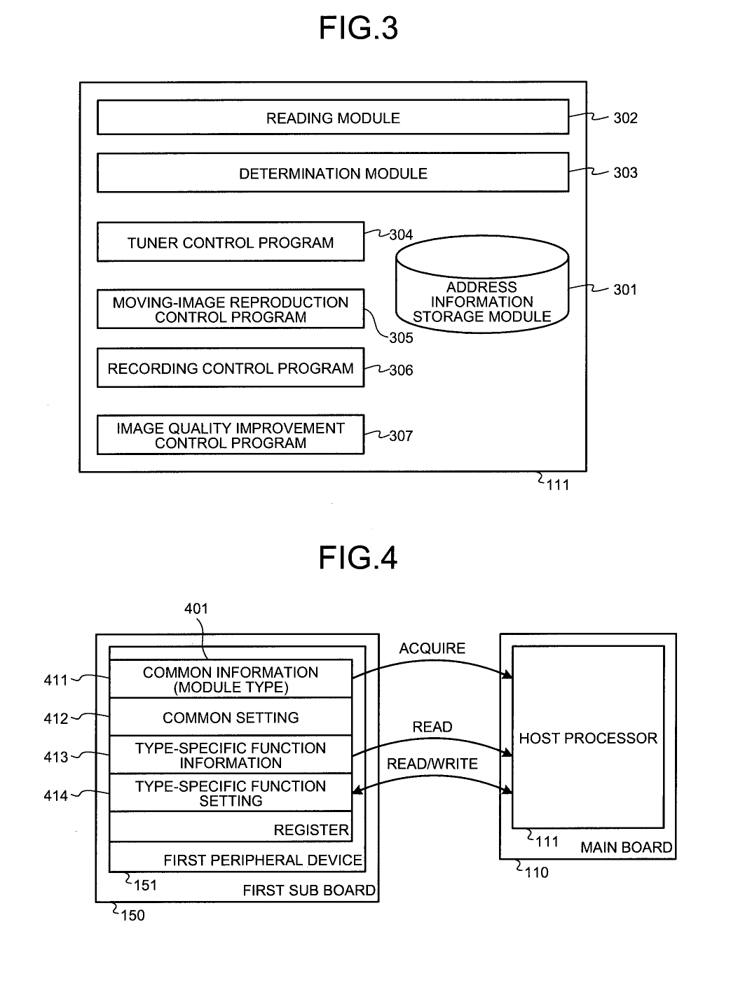

FIG. 3 is a diagram illustrating a software configuration realized by the host processor 111 according to the present embodiment. As illustrated in FIG. 3, the host processor 111 comprises a reading module 302, a determination module 303, a tuner control program 304, a moving-image reproduction control program 305, a recording control program 306, and an image quality improvement control program 307. Further, an address information storage module 301 is provided in a memory provided in the host processor 111 according to the present embodiment.

In the registers in the peripheral devices in the sub boards according to the present embodiment (all including the tuner board 210, the USB moving-image reproducer 220, the recorder 230, the image quality improvement device 240 and the like that are connectable to the main board 110), address areas for storing common information are the same among all.

Meanwhile, the common information is information common to the sub boards, and includes identification information for identifying a type of a module of a sub board (hereinafter, also referred to as a module type). Further, modules according to the present embodiment are functions that can be implemented by the sub boards. The present embodiment is described with an example in which a tuner, a moving image function, a recording function, and an image quality improvement function are present as the module types; however, other module types may be included.

The address areas storing the common information in all of the sub boards are the same; therefore, the reading module 302 can acquire the common information by accessing predetermined address areas of the registers (not illustrated) in the sub boards connected to the main board 110 via the control interfaces 213, 223, 233, and 243. In other words, the reading module 302 can recognize the module types of the connected sub boards by referring to the common information in the sub boards.

The determination module 303 determines programs that control the respective sub boards according to the common information (module types) acquired by the reading module 302. In the present embodiment, the tuner control program 304, the moving-image reproduction control program 305, the recording control program 306, and the image quality improvement control program 307 are assigned, as the programs that control the respective sub boards, in accordance with the common information (module types) acquired from the connected sub boards.

In the present embodiment, if the module types of the sub boards are the same, the same program performs control independent of a difference between products of the sub boards (a difference in the providing destination region or performance). Further, even when a function is newly expanded in a sub board of the same module type, conventional programs can control conventionally-implemented functions. For example, it is assumed that a function D is newly added to a module of a sub board equipped with functions A, B, and C. In this case, it is necessary to extend the area of a register provided in the sub board to allocate an address area for the function D. In this case, it is necessary to correct a program to use the function D; however, the same address areas as conventional ones are allocated for the functions A, B, and C that have conventionally been used, and therefore, conventional programs can implement compatible operations.

FIG. 4 is a conceptual diagram illustrating a control method of the main board 110 and the sub board of the present embodiment. In the example illustrated in FIG. 4, common information 411, common setting 412, type-specific function information 413, and type-specific function setting 414 are allocated in a register 401 provided in the first peripheral device 151 of the first sub board 150.

Further, the common information 411 and the common setting 412 are allocated to addresses common to the registers of all of the sub boards.

The common information 411 stores therein a module type of the sub board 150. The common information 411 is stored in predetermined address areas in the registers of all of the sub boards. Namely, in the present embodiment, the reading module 302 can specify a type of a module (hereinafter, referred to as a module type) of each of the sub boards by referring to the address area that is determined in advance (for the common information 411) in the register provided in each of the sub boards.

The common setting 412 stores therein a setting common to the sub boards independent of the module types. The common setting 412 is stored in predetermined address areas in the registers of all of the sub boards. Namely, in the present embodiment, the determination module 303 performs control common to the sub boards by performing write to the address area that is determined in advance for the common setting 412 in the register provided in each of the sub boards.

Meanwhile, the module types according to the present embodiment indicate types of sub boards that are connectable to the main board 110 of the video processing device 100 according to the present embodiment. In the host processor 111 of the main board 110 according to the present embodiment, programs generated for the respective module types are installed.

In other words, a program generated for each module type can control sub boards connected to the main board 110 as long as module types are the same. Namely, in the present embodiment, a control program is provided for each one of module types, and the control program acquires an attribute (for example, presence or absence of a supported function) of a subject sub board from a predetermined first address area, and writes a setting (for example, a setting related to the supported function) to a corresponding predetermined second address area. Consequently, it becomes possible to implement a common operation on multiple types of modules. In other words, address structures of the registers are made identical for each one of the module types, and therefore, the main board 110 can perform control even when any sub boards are connected, as long as the module types are dealt with.

The type-specific function information 413 and the type-specific function setting 414 illustrated in FIG. 4 are allocated to common address areas for each module type. Namely, if the module types are the same, the address areas of the type-specific function information 413 and the type-specific function setting 414 are the same among the registries in the sub boards.

The type-specific function information 413 is a common address area of each module type, and is an area in which attribute information on each module type is stored. Further, the type-specific function setting 414 is a common address area of each module type, and is an area in which a common setting on each module type is written.

Namely, the reading module 302 of the host processor 111 of the main board 110 according to the present embodiment acquires the common information 411 or the like from the register 401 in the first peripheral device 151 of the connected sub board 150. Accordingly, a module type of the sub board is specified. Then, a program corresponding to each module type controls each sub board; at this time, the program reads an attribute of each sub board (a function or the like for each module type) from the common address area (the type-specific function information 413) for the module type, and performs setting on the common address area (the type-specific function setting 414) for the module type. Consequently, the program corresponding to each module type can control sub boards independent of a difference in the providing destination region and performance, as long as the respective module types are the same.

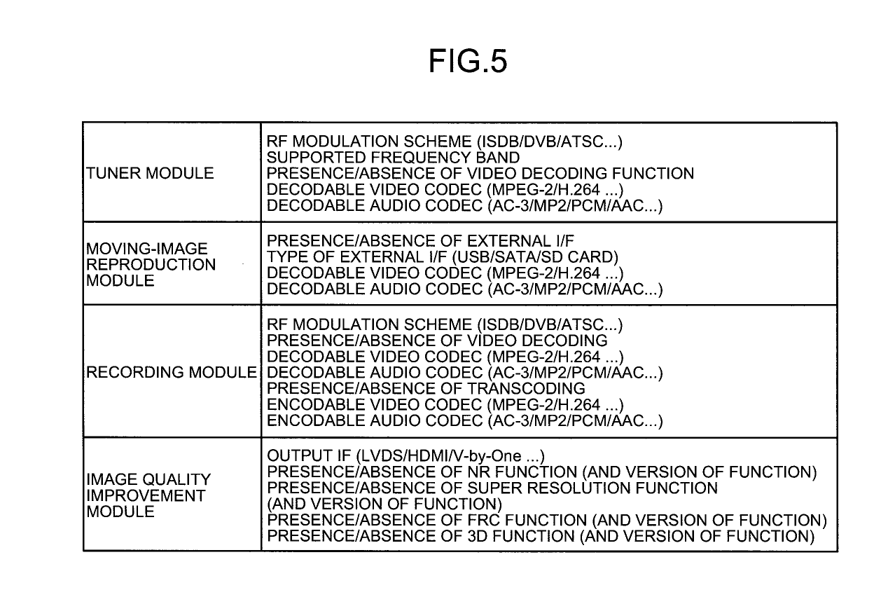

FIG. 5 is a diagram illustrating an example of the type-specific function information for each module type according to the present embodiment. In the example illustrated in FIG. 5, the type-specific function information is determined in advance for each of module types (a tuner module, a moving-image reproduction module, a recording module, and an image quality improvement module). Further, in the present embodiment, a program for each module type can specify a function (attribute) supported by each sub board by referring to the type-specific function information on each sub board. Furthermore, the program for each module type controls a sub board by performing write to the type-specific function setting such that the function supported by the sub board can be used if needed.

As illustrated in FIG. 5, in a register of a sub board of the tuner module, a supported “RF modulation scheme”, a “frequency band”, “presence or absence of a video decoding function”, a “decodable video codec”, and a “decodable audio codec” are stored, as the type-specific function information, in an address area common to tuner modules. Further, the tuner control program 304 corresponding to the tuner module refers to the type-specific function information, and thereafter sets, in an address area of the type-specific function setting, a function (attribute) that is determined to be available by the type-specific function information.

More specifically, if it is recognized, with reference to the type-specific function information, that ISDB-T (a supported frequency band: 470 MHz to 770 MHz) and ISDB-S (a supported frequency band: 11.7 GHz to 12.2 GHz) are supported as the RF modulation scheme, that a video decoding function is provided, that a supported video codec is MPEG-2 VIDEO, and that a supported audio codec is MPEG-2 AAC, the tuner control program 304 of the host processor 111 can set the RF modulation scheme, the frequency bands, ON/OFF of the video decoding function, the video codec, and the audio codec by performing write to the type-specific function setting.

Incidentally, as for the other module types (the moving-image reproduction module, the recording module, and the image quality improvement module), corresponding programs perform the same control, and therefore, explanation thereof will be omitted. Meanwhile, FIG. 5 is not intended to limit the controllable attributes (functions), and it may be possible to set other attributes (functions) or the like.

Referring back to FIG. 3, the tuner control program 304 accesses, upon controlling a sub board whose module type in the common information is a tuner (for example, the tuner board 210), a predetermined address area that is common to tuner modules and that is in a register provided in the sub board (for example, the tuner board 210) as described above.

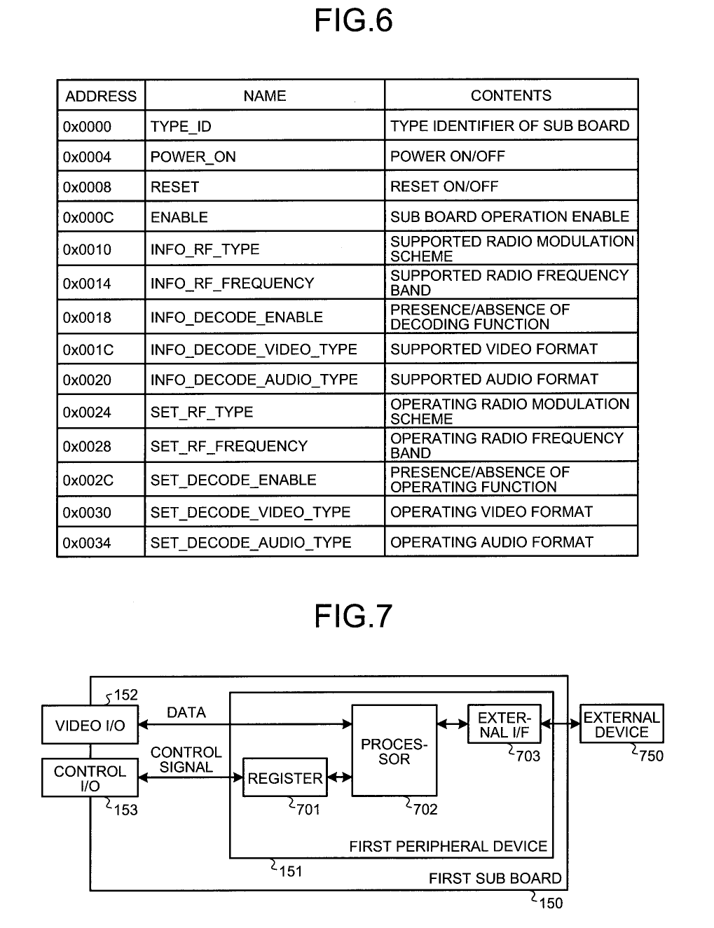

The address area common to the tuner modules is stored in the address information storage module 301. FIG. 6 is a diagram illustrating an example of address map of the register of the tuner module, which is stored in the address information storage module 301. In the example illustrated in FIG. 6, a name and contents are associated with each address.

In the example illustrated in FIG. 6, common information, in particular, a type identifier (module type) of a sub board is stored in “0x0000”. Further, common settings, in particular, power ON/OFF, reset ON/OFF, and sub board operation enable are stored in “0x0004” to “0x000C”.

Furthermore, the type-specific function information, in particular, a supported radio conversion scheme, a supported radio frequency band, presence or absence of a decoding function, a supported video format, and a supported audio format are stored in “0x0010” to “0x0020”.

Similarly, the type-specific function setting, in particular, an operating radio conversion scheme, an operating radio frequency band, presence or absence of an operating function, an operating video format, and an operating audio format are stored in “0x0024” to “0x0034”.

Further, the address information storage module 301 stores therein not only the address area common to the tuner modules but also a common address of this module type, for each of the module types available to the main board 110, in an associated manner. The address information storage module 301 according to the present embodiment stores therein the common information, the type-specific function information from which an attribute of a sub board is to be read, and the address of the type-specific function setting in which a function executed by the sub board is to be set, for each of the module types available to the main board 110.

Further, the tuner control program 304 reads an attribute (function) supported by the connected sub board by referring to the type-specific function information on the register of the sub board, in particular, the supported radio conversion scheme, the supported radio frequency band, the presence or absence of the decoding function, the supported video format, and the supported audio format, in accordance with the address map stored in the address information storage module 301.

Furthermore, the tuner control program 304 controls the sub board by performing write to addresses of the register of the sub board, which are associated with the operating radio conversion scheme, the operating radio frequency band, the presence or absence of the operating function, the operating video format, and the operating audio format in the address map stored in the address information storage module 301, based on a reference result.

Incidentally, the present embodiment is described with an example in which the address information storage module 301 stores therein the address map of the register of the tuner module for simplicity of explanation; however, the way of storage is not limited to the storage module, and in-advance incorporation in the tuner control program is applicable.

The moving-image reproduction control program 305 controls a sub board whose module type is a moving image function. The recording control program 306 controls a sub board whose module type is a recording function. The image quality improvement control program 307 controls a sub board whose module type is an image quality improvement function.

Further, the moving-image reproduction control program 305, the recording control program 306, and the image quality improvement control program 307 refer to the common type-specific function information for the respective module types, and perform write to the common type-specific function setting for the respective module types, to thereby control the sub boards. Meanwhile, detailed processes are the same as the processes performed by the tuner control program 304, and explanation thereof will be omitted.

In the video processing device 100 according to the present embodiment, it is possible to switch between supported functions by replacing a sub board. In this manner, even when the sub board is replaced, as long as a newly-connected sub board coincides with the module type supported by the main board 110, it can be used without development or installation of a new program or the like.

Next, a configuration of the sub board will be described. FIG. 7 is a diagram illustrating a structure of the first sub board according to the present embodiment. As illustrated in FIG. 7, the first peripheral device 151 mounted on the first sub board 150 comprises a register 701, a processor 702, and an external interface (I/F) 703. Further, the first sub board 150 is connected to an external device 750 via the external interface (I/F) 703. Meanwhile, the first sub board 150 represents a concept common to the above described sub boards (the tuner board 210, the USB moving-image reproducer 220, the recorder 230, and the image quality improvement device 240).

Furthermore, the first sub board 150 comprises the video interface 152 and the control interface 153, which are connectable to the main board 110 that uses functions implemented by the first sub board 150.

A control signal from the host processor 111 is input to the first peripheral device 151 via the control interface 153. The control signal is input to the register 701 inside the first peripheral device 151. If the control signal is a read command, the first peripheral device 151 reads register information at a corresponding address and outputs it to the host processor 111. On the contrary, if the control signal is a write command, the first peripheral device 151 writes corresponding data to a corresponding address. Then, the processor 702 operates according to the data written in the register 701.

The register 701 is a storage module capable of performing read and write with respect to the host processor 111 via the control interface 153. The register 701 stores the type-specific function information and the type-specific function setting for using functions of the first sub board 150, in the same address area as a register of a sub board that realizes the same functions as the first sub board 150 (with the same module types).

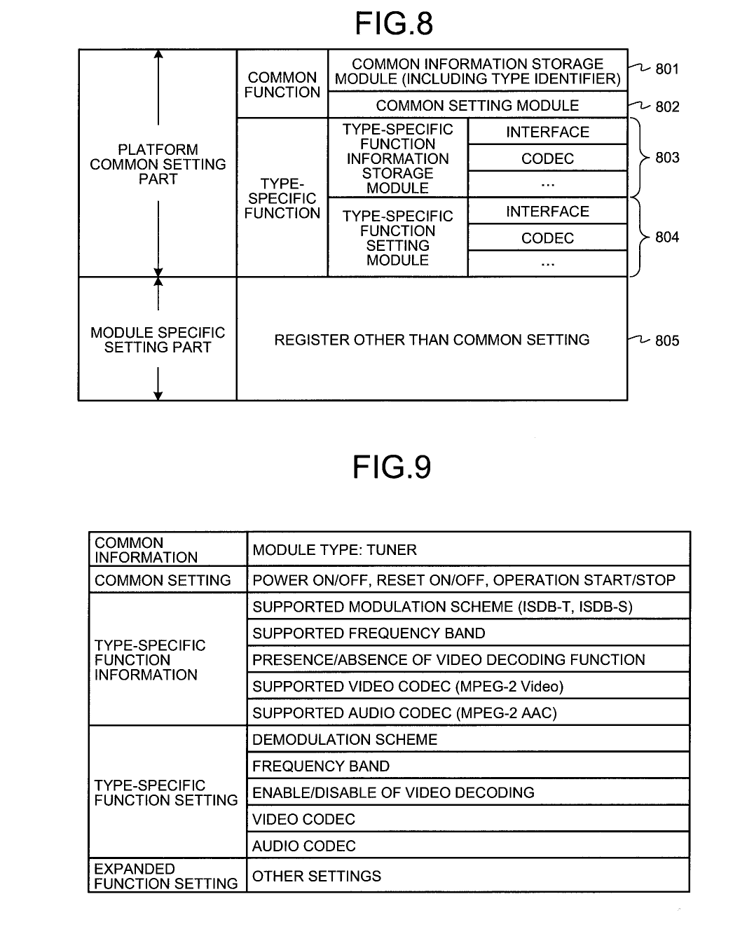

FIG. 8 is a diagram illustrating a structure of the register 701 in the first peripheral device 151 mounted on the sub board 150 according to the present embodiment.

In the register 701 illustrated in FIG. 8, a platform common setting part and a module specific setting part 805 are allocated. The platform common setting part is an address area common to sub boards of the same module type.

The platform common setting part is further divided into a common function and a type-specific function. The common function is an address area common to all of the sub boards, and includes a common information storage module 801 and a common setting module 802. The type-specific function is an address area common to only sub boards of the same module type, and includes a type-specific function information storage module 803 and a type-specific function setting module 804.

The common information storage module 801 stores therein a type identifier for identifying a module type. The common setting module 802 comprises a register for controlling functions of performing control on the entire sub board, such as power ON/OFF control, reset control, and ON/OFF of operations of the sub board, independent of the module type.

A register configuration of the type-specific function is determined by the type identifier in the common information storage module 801, in other words, by the module type. The type-specific function information storage module 803 stores therein presence or absence of a function supported by the first peripheral device 151 and a type of the supported function. Further, the type-specific function setting module 804 is an address area for setting the function that is determined to be supported in the type-specific function information storage module 803.

The module specific setting part 805 is an address area different from other sub boards, and is an address area used when the sub board 150 performs control different from the other sub boards. The module specific setting part 805 is an address area which is referred to and to which write is performed by only the sub board 150, and which is not referred to and to which write is not performed by the main board 110.

Next, a detailed register configuration will be described for each module type. FIG. 9 is a diagram illustrating a register configuration of the tuner board 210 according to the present embodiment. In the example illustrated in FIG. 9, “module type: tuner” is stored as the common information. Further, attributes corresponding to the “module type: tuner” are assigned to the type-specific function information and the type-specific function setting. Furthermore, an expanded function setting is an address area allocated for an attribute or the like uniquely expanded for each sub board.

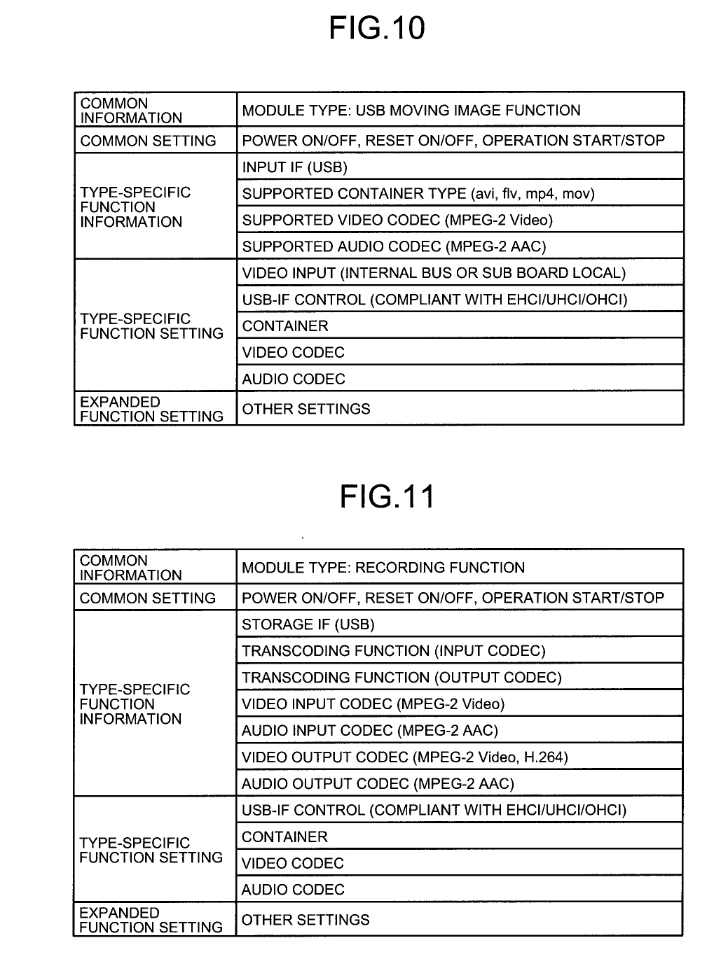

FIG. 10 is a diagram illustrating a register configuration of the moving image function according to the present embodiment. In the example illustrated in FIG. 10, “module type: moving image function” is stored as the common information. Further, attributes corresponding to the “module type: moving image function” are assigned to the type-specific function information and the type-specific function setting. Furthermore, an expanded function setting is an address area allocated for an attribute or the like uniquely expanded for each sub board.

FIG. 11 is a diagram illustrating a register configuration of the recording function according to the present embodiment. In the example illustrated in FIG. 11, “module type: recording function” is stored as the common information. Further, attributes corresponding to the “module type: recording function” are assigned to the type-specific function information and the type-specific function setting. Furthermore, an expanded function setting is an address area allocated for an attribute or the like uniquely expanded for each sub board.

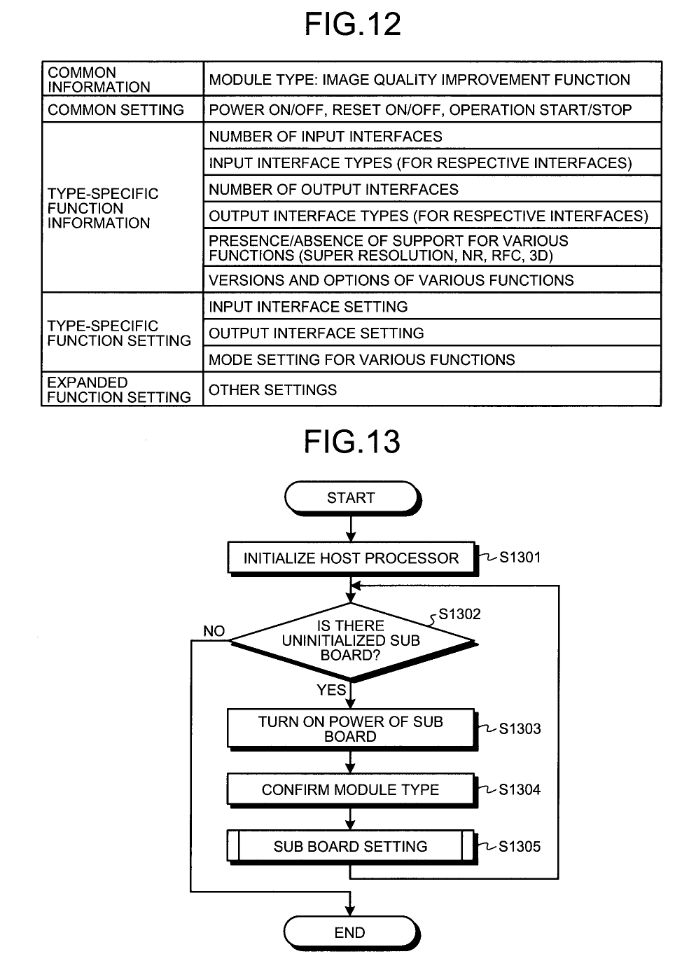

FIG. 12 is a diagram illustrating a register configuration of the image quality improvement function according to the present embodiment. In the example illustrated in FIG. 12, “module type: image quality improvement function” is stored as the common information. Further, attributes corresponding to the “module type: image quality improvement function” are assigned to the type-specific function information and the type-specific function setting. Furthermore, an expanded function setting is an address area allocated for an attribute or the like uniquely expanded for each sub board.

Referring back to FIG. 7, the processor 702 refers to the function settings (attributes) stored in the register 701, and executes functions according to the function settings. Namely, the processor 702 performs a process according to a setting written by a program for each module type executed by the host processor 111 of the main board 110.

The processor 702 may communicate video or other data with the main board 110 or other sub boards via the control interface 153 for data communication, if needed. Further, the processor 702 may communicate data with the external device 750 via the external interface 703.

The external I/F 703 is an interface for connecting to the external device 750.

Next, a process performed at the time of activation of the video processing device 100 according to the present embodiment will be described. FIG. 13 is a flowchart illustrating the flow of the above described process in the video processing device 100 according to the present embodiment. In the example illustrated in FIG. 13, initialization is described, which is performed when power of the video processing device 100 is turned on or hardware is reset.

First, when the video processing device 100 is activated, the host processor 111 is initialized (Step S1301). Accordingly, the host processor 111 executes a control program, and the reading module 302, the determination module 303, the tuner control program 304, the moving-image reproduction control program 305, the recording control program 306, and the image quality improvement control program 307 are realized as a software configuration.

Subsequently, all of the sub boards are sequentially initialized. Specifically, the reading module 302 reads the register of each of the connected sub boards, and thereafter, the determination module 303 determines whether there is an uninitialized sub board among the read sub boards (Step S1302).

Then, if the determination module 303 determines that there is an uninitialized sub board (Step S1302: Yes), the determination module 303 writes power-ON in the common setting (power ON/OFF) stored in the register of the uninitialized sub board to perform setting to turn on the power of this sub board (Step S1303).

Subsequently, the determination module 303 confirms a module type from the common information read by the reading module 302 (Step S1304).

Based on the module type confirmed by the determination module 303, a program corresponding to this module type (the tuner control program 304, the moving-image reproduction control program 305, the recording control program 306, or the image quality improvement control program 307) sets a sub board (Step S1305).

If, at Step S1302, the determination module 303 determines that there is no uninitialized sub board (Step S1302: No), all of initial settings are finished.

Incidentally, the present embodiment is not limited to the initialization of all of the sub boards, and it may be possible not to perform the initialization according to settings performed by a user or the like. In this case, it may be possible to turn off the power of the sub board to save electricity, or it may be possible to maintain the power-on to reduce a time for resetting.

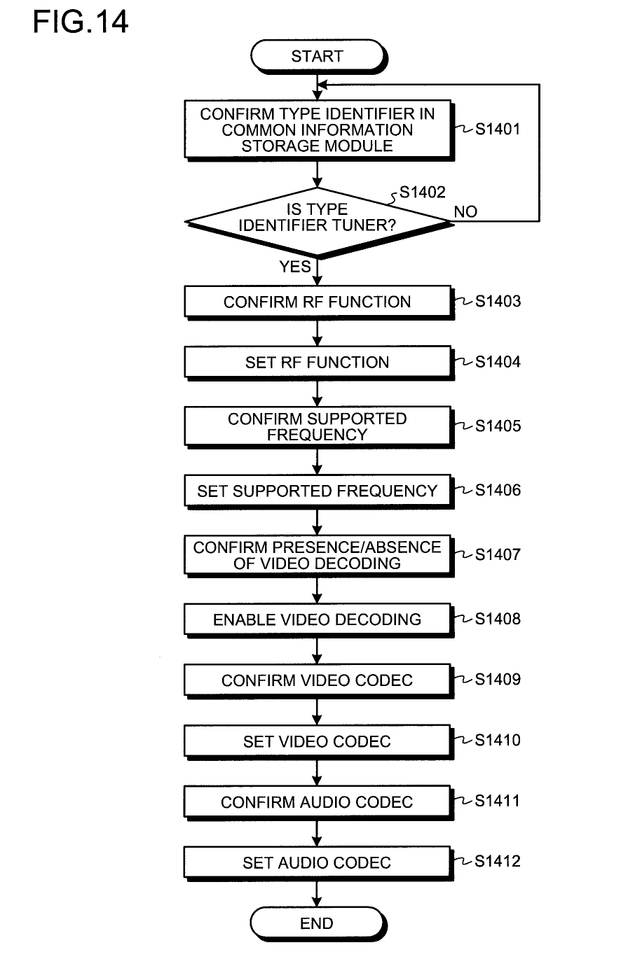

Next, setting of a peripheral equipment will be described in detail. FIG. 14 is a flowchart illustrating the flow of setting a tuner module in the video processing device 100 according to the present embodiment. In the flowchart illustrated in FIG. 14, an example is described in which the tuner control program 304 is called. More specifically, an example will be described in which setting of terrestrial digital broadcasting is performed on a tuner module that deals with Japanese terrestrial digital broadcasting and BS/CS digital broadcasting.

First, the reading module 302 of the host processor 111 reads common information on a subject sub board (Step S1401). Then, the determination module 303 determines whether or not a read-target sub board is a tuner according to the common information read by the reading module 302 (Step S1402). If the determination module 303 determines that the sub board is not a tuner (Step S1402: No), it instructs the reading module 302 to read common information on a different sub board and starts the process from Step S1401 again. Meanwhile, if it has already been recognized that the sub board is a tuner module as in the case of the initialization, processes at Step S1401 and S1402 are not performed.

Then, if the determination module 303 determines that the module type of the read-target sub board is a tuner (Step S1402: Yes), it sets this sub board based on the type-specific function information and the type-specific function setting stored in the register of this sub board.

Namely, the tuner control program 304 refers to the type-specific function information in the register of the sub board and confirms a support modulation scheme (ISDB-T, ISDB-S) (Step S1403). Subsequently, the tuner control program 304 writes a setting of, for example, “ISDB-T” in the address area to which a demodulation scheme is assigned in the type-specific function setting in the register of the sub board, to thereby set the demodulation scheme (Step S1404).

Subsequently, the tuner control program 304 refers to the type-specific function information in the register of the sub board, and confirms a supported frequency band (for example, (470 MHz to 770 MHz)) (Step S1405). Thereafter, the tuner control program 304 writes, for example, “470 MHz” in the address area to which the frequency band is assigned in the type-specific function setting in the register of the sub board, to thereby set the frequency band (Step S1406).

Then, the tuner control program 304 refers to the type-specific function information in the register of the sub board, and confirms presence or absence of a video decoding function (Step S1407). Thereafter, the tuner control program 304 writes information indicating “enable” in the address area to which enable/disable of video decoding is assigned in the type-specific function setting in the register of the sub board, to thereby enable the video decoding (Step S1408).

Subsequently, the tuner control program 304 refers to the type-specific function information in the register of the sub board and confirms a supported video codec (Step S1409). Thereafter, the tuner control program 304 writes, for example, “MPEG-2 VIDEO” in the address area to which the video codec is assigned in the type-specific function setting in the register of this sub board, to thereby set the video codec (Step S1410).

Then, the tuner control program 304 confirms a supported audio codec by referring to the type-specific function information in the register of the sub board (Step S1411). Thereafter, the tuner control program 304 writes “MPEG-2 AAC” in the address area to which the audio codec is assigned in the type-specific function setting in the register of the sub board, to thereby set the audio codec (Step S1412).

Through the above described processing flow, initialization of the tuner module is realized based on the type-specific function information and the type-specific function setting. In the flowchart illustrated in FIG. 14, an example has been described in which the setting of the tuner module is performed based on the type-specific function information and the type-specific function setting of the tuner module. Meanwhile, the same is performed on the other module types based on the type-specific function information and the type-specific function setting of the corresponding module type, and explanation will be omitted.

### Modification of First Embodiment

In the first embodiment, a case has been described in which fixed addresses are employed as the register configurations in the peripheral devices of the sub boards. However, it is not limited to the method of employing the fixed addresses for all of the register configurations.

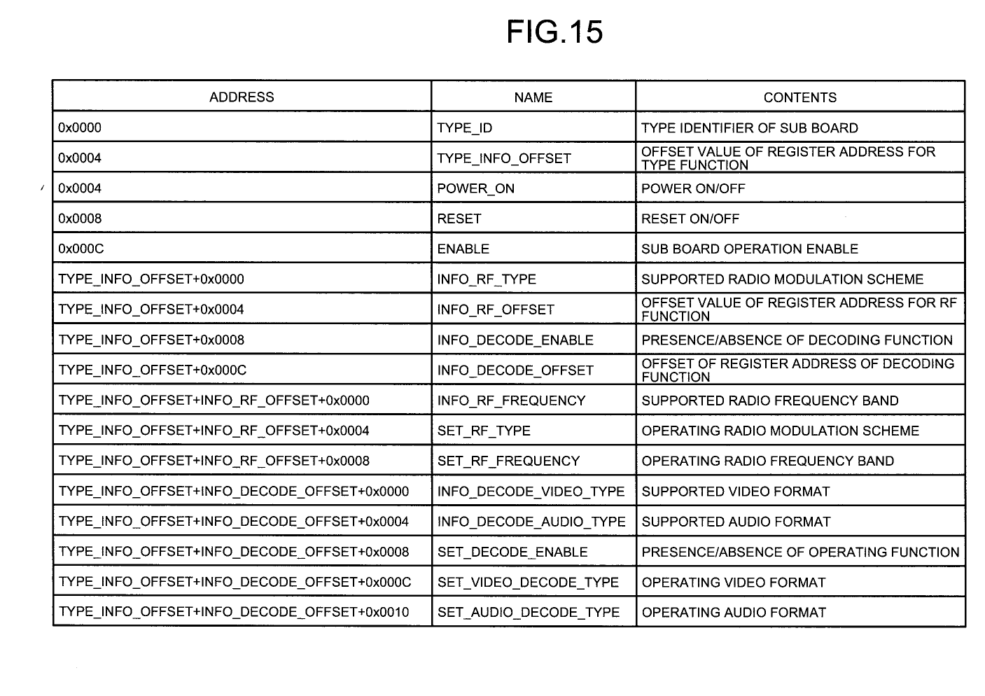

FIG. 15 is a diagram illustrating an example of address mapping of a register in a tuner controller of a tuner module according to a modification of the first embodiment. In the example illustrated in FIG. 15, an address area for setting an “offset value of a register address for a type function” is allocated. Each of the tuner modules can flexibly set address areas for the type-specific function information and the type-specific function setting by setting the “offset value of a register address for a type function”. Therefore, it becomes possible to flexibly cope with address enhancement including future compatibility.

### Second Embodiment

In the first embodiment, an example has been described in which the address areas of the registers inside the sub boards are commonly allocated according to the module types. However, to realize common address areas, sub boards of the same module type need to be designed such that register configurations become the same. Therefore, in the present embodiment, an embodiment that reduces a burden of developing the sub board will be described. Meanwhile, the main board is the same as the first embodiment, and explanation thereof will be omitted.

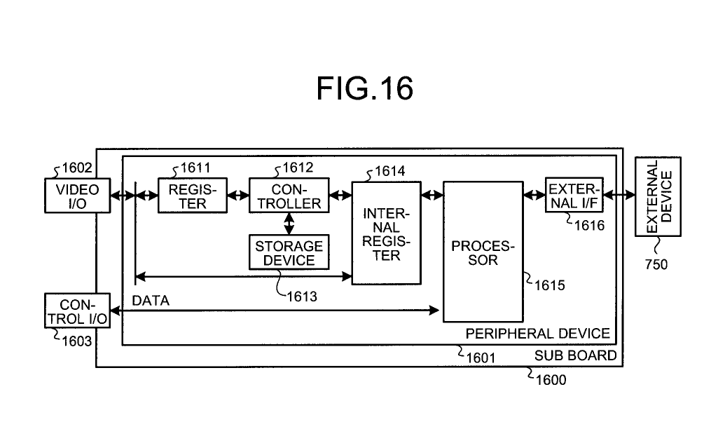

Next, a configuration of the sub board according to the present embodiment will be described. FIG. 16 is a diagram illustrating a structure of the sub board according to the present embodiment. As illustrated in FIG. 16, a peripheral device 1601 mounted on a sub board 1600 comprises a register 1611, a controller 1612, a storage device 1613, an internal register 1614, a processor 1615, and an external interface (I/F) 1616. Further, the sub board 1600 is connected to an external device 750 via the external interface (I/F) 1616.

Furthermore, the sub board 1600 according to the present embodiment comprises a video interface 1602 and a control interface 1603, which are connectable to the main board 110 that uses functions realized by the sub board 1600.

Similarly to the first embodiment, a control signal from the host processor 111 is input to the peripheral device 1601 via the control interface 1603. The control signal is input to the register 1611 inside the peripheral device 1601. If the control signal is a read command, the peripheral device 1601 reads register information at a corresponding address, and outputs it to the host processor 111. On the contrary, if the control signal is a write request, the peripheral device 1601 writes corresponding data to a corresponding address.

The register 1611 is, similarly to the first embodiment, a storage module capable of performing read and write from and to the host processor 111. The register 1611 stores the type-specific function information and the type-specific function setting at the same addresses as in a register of a sub board of the same module type.

The controller 1612 is connected to the internal register 1614, refers to a function setting (attribute) stored in the internal register 1614, and executes a function according to the function setting.

The configuration of the internal register 1614 need not be the same as the configurations of other sub boards, and an arbitrary configuration is applicable.

Namely, in the present embodiment, the host processor 111 performs control by using the register 1611 to enable the same control as performed on the other sub boards, and the processor 1615 performs processes by referring to the internal register 1614.

Then, the controller 1612 performs control of converting the function setting written in the register 1611 into a format that can directly be referred to by the processor 1615 and performing write to the internal register 1614. Consequently, the processor 1615 can perform processes based on the converted settings. Namely, the processor 1615 need not refer to an address area common to the other sub boards.

The storage device 1613 stores therein a program that controls the controller 1612, a parameter for converting the function setting written in the register 1611 into the setting for the internal register 1614, or the like.

In this manner, when the processor 1615 itself is not able to recognize the setting written by the host processor 111 of the main board 110, the controller 1612 performs conversion into a format that can be referred to by the processor 1615, so that the host processor 111 of the main board 110 can control the sub board 1600 of the present embodiment.

Namely, the processor 702 according to the first embodiment is designed so as to be able to recognize setting information written by the host processor 111; however, to do this, it is necessary to newly develop the processor 702. Therefore, when it is desired to use a conventionally used processor or it is desired to apply a processor provided by other companies or the like, it is possible to realize a connection between the main board 110 and the sub board 1600 by converting the processor in an appropriate format by the controller 1612, without newly developing the processor. That is, in the present embodiment, the controller 1612 operates as a wrapper that covers a difference between the host processor 111 and the processor 1615.

Further, it may be possible to cause the controller 1612, when writing a setting that can be referred to by the processor 1615 in the internal register 1614, to perform write so as to set a different value for each region. With this, it is possible to easily realize a setting optimal to each region.

Furthermore, in the present embodiment, the controller 1612 can realize variations specific to products or differentiation between lineups by setting different values for respective products. For example, in the image quality improvement module, when panels with different specifications are used for respective lineups, or when there are variations between individual products even when panels with the same specifications are used for models of the same lineup, it is possible to realize multiple settings by changing setting values in the storage device 1613.

In the above described embodiments, a common control method is provided between the main board and the sub board for each module type. Therefore, even when the sub board is changed, it is possible to operate the sub board without changing software on the host processor of the main board. Consequently, it is possible to use the same program independent of the connected sub board, enabling to reduce developing periods, developing burdens, and developing costs.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A function control device comprising:
an interface connectable to at least one of multiple types of function adding devices;
an acquisition module that acquires, from the function adding device connected via the interface, function information indicating a function executed by the function adding device; and
a controller that accesses, upon controlling the function indicated by the function information acquired by the acquisition module, an address which is determined as a common address for the function identified by the function information and which is in a storage module comprised in the function adding device connected via the interface.

2. The function control device of claim 1, further comprising:
an address information storage module that stores therein, for each one of the functions, an address common to the multiple types of the function adding devices that provide the one of the functions, wherein
the controller controls, when the one of the functions is to be used, the one of the functions by accessing the storage module which is indicated by the address stored in the address information storage module and which is provided in the function adding device.

3. The function control device of claim 2, wherein
the address information storage module further stores therein, for each one of the functions, a setting address common to the multiple types of the function adding devices that provide the one of the functions, as a destination for which the one of the functions executed by the function adding device connected via the interface is set, and
the controller controls, when the one of the functions is to be used, the one of the functions by performing write to the storage module which is indicated by the setting address stored in the address information storage module and which is provided in the function adding device.

4. The function control device of claim 2, wherein
the address information storage module further stores therein, for each one of the functions, an attribute address common to the multiple types of the function adding devices that provide the one of the functions, as a destination from which an attribute provided in the function adding device connected via the interface is read, and
the controller controls, when the one of the functions is to be used, the one of the functions based on the attribute read from the storage module which is indicated by the attribute address stored in the address information storage module and which is provided in the function adding device.

5. The function control device of claim 1, wherein the controller executes a control program that controls, for each one of the functions, the multiple types of the function adding devices that provide the one of the functions.

6. A function adding device comprising:
an interface connectable to a function control device that uses a function implemented by the function adding device;
a first storage module that serves as a storage module capable of performing read and write with respect to the function control device via the interface, and stores, in a same address as a storage module provided in another function adding device having a same function as the function adding device, setting information for using the function; and
a controller that executes the function based on the setting information stored in the first storage module.

7. The function adding device of claim 6, further comprising:
a second storage module that is directly referred to by the controller; and
a conversion module that converts the setting information stored in the first storage module into a format that can be directly referred to by the controller, and write the setting information in the second storage module, wherein
the controller refers to the setting information written in the second storage module and executes the function.
